(19) United States
(12) Patent Application Publication
(10) Pub. No.: US 2006/0229880 A1
(43) Pub. Date: Oct. 12, 2006

(54) Remote control of an appliance using a multimodal browser

(75) Inventors: Marc White, Boca Raton, FL (US); Jeff Paull, Coral Springs, FL (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/093,545

(22) Filed: Mar. 30, 2005

(51) Int. Cl. G10L 21/00

(52) U.S. Cl. 704/275

(57) ABSTRACT

A system, a method and machine readable storage for remotely controlling an appliance using multimodal access. The system can include a multimodal control device having a multimodal user interface, which receives at least one user input comprising a spoken utterance. The system also can include a wireless transmitter that propagates an appliance control command correlating to the user input to remotely control the appliance. The method can include receiving at least one user input comprising a spoken utterance via a multimodal user interface, and propagating from a wireless transmitter an appliance control command correlating to the user input to remotely control the appliance.

### BACKGROUND

1. Field of the Invention

The present invention relates to the remote control of electronic devices.

2. Description of the Related Art

Web enabled devices are currently being developed to incorporate multimodal access in order to make communication over the Internet more convenient. Multimodal access is the ability to combine multiple input/output modes in the same user session. Typical multimodal input methods include the use of speech recognition, a keypad/keyboard, a touch screen, and/or a stylus. For example, in a Web browser on a personal digital assistant (PDA), one can select items by tapping a touchscreen or by providing spoken input. Similarly, one can use voice or a stylus to enter information into a field. With multimodal technology, information presented on the device can be both displayed and spoken.

To facilitate implementation of multimodal access, multimodal markup languages which incorporate both visual markup and voice markup have been developed. Such languages are used for creating multimodal applications which offer both visual and voice interfaces. One multimodal markup language set forth in part by International Business Machines Corporation of Armonk, N.Y. is called XHTML+Voice, or simply X+V. X+V is an XML based markup language that synchronizes extensible hypertext markup language (XHTML), a visual markup, with voice extensible markup language (VoiceXML), a voice markup.

Another multimodal markup language is the Speech Application Language Tags (SALT) language as set forth by the SALT forum. SALT extends existing visual mark-up languages, such as HTML, XHTML, and XML, to implement multimodal access. More particularly, SALT comprises a small set of XML elements that have associated attributes and document object model (DOM) properties, events and methods.

Both X+V and SALT have capitalized on the use of pre-existing markup languages to implement multimodal access. Notwithstanding the convenience that such languages bring to implementing multimodal access on computers communicating via the Internet, multimodal technology has not been extended to other types of consumer electronics. In consequence, consumers currently are denied the benefit of using multimodal access to interact with other household appliances.

### SUMMARY OF THE INVENTION

The present invention provides a solution for remotely controlling an appliance using multimodal access. One embodiment of the present invention pertains to a system which includes a multimodal control device. The multimodal control device can incorporate a multimodal user interface which receives at least one user input comprising a spoken utterance. The system also can include a wireless transmitter that propagates an appliance control command correlating to the user input to remotely control the appliance.

Another embodiment of the present invention pertains to a method for remotely controlling an appliance. The method can include receiving at least one user input comprising a spoken utterance via a multimodal user interface, and propagating from a wireless transmitter an appliance control command correlating to the user input to remotely control the appliance.

Another embodiment of the present invention can include a machine readable storage being programmed to cause a machine to perform the various steps described herein.

### BRIEF DESCRIPTION OF THE DRAWINGS

There are shown in the drawings, embodiments that are presently preferred; it being understood, however, that the invention is not limited to the precise arrangements and instrumentalities shown.

FIG. 1 is a schematic diagram illustrating a system that remotely controls an appliance in accordance with an embodiment of the present invention.

FIG. 2 is a flow chart illustrating a method of remotely controlling an appliance in accordance with an embodiment of the present invention.

### DETAILED DESCRIPTION OF THE INVENTION

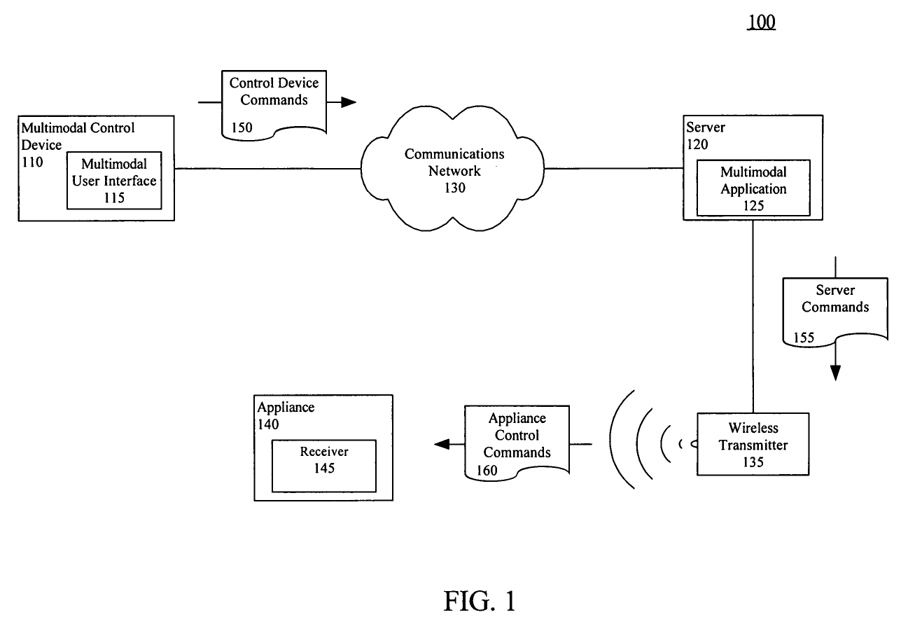

FIG. 1 is a schematic diagram illustrating a system 100 that remotely controls an appliance 140 using multimodal access in accordance with an embodiment of the present invention. The system can include a multimodal control device (hereinafter “control device”) 110 having a multimodal user interface 115. For instance, the control device 110 can be an information processing system. Examples of suitable information processing systems include desktop computers, laptop computers, handheld computers, personal digital assistants (PDAs), telephones, or any other information processing systems having audio and visual capabilities suitable for presenting the multimodal user interface 115.

The control device 110 can execute a multimodal browser which generates a multimodal user interface 115 by rendering multimodal markup language documents. The multimodal user interface 115 can receive user inputs for remotely controlling appliances. The multimodal browser can be, for example, a browser optimized to render X+V and/or SALT markup languages. The multimodal browser can present data input fields, buttons, keys, check boxes, or any other suitable data input elements, one or more of which are voice enabled. Conventional tactile keys, for instance those contained in a conventional remote control unit or on a keyboard, also can be provided for receiving tactile user inputs.

The multimodal user interface 115 can include, access, or provide data to audio processing services such as text-to-speech (TTS), speech recognition, and/or dual tone multi-frequency processing. These services can be located on the control device 110 or can be located in a different computing system that is communicatively linked with the control device 110. For example, the multimodal user interface 115 can access or provide data to audio processing services via a multimodal application 125 located on a server 120. Thus, by way of example, the multimodal browser can receive a user input to select a particular data input element, and then receive one or more spoken utterances to associate data with the data input element. For instance, the user can select a particular channel and assign a spoken utterance to be associated with that channel, such as “sports”, “news”, “WPBTV”, “10”, etc.

User inputs received via the multimodal user interface 115 can be processed to generate correlating control device commands 150. The user inputs can include spoken utterances and/or non-speech user inputs, such as tactile inputs, cursor selections and/or stylus inputs. In an arrangement in which the control device 110 includes speech recognition, the control device commands 150 can include textual representations of the spoken utterances received by the control device 110, for instance text data or data strings. In an arrangement in which the speech recognition is located on the server, the control device commands 150 can include audio representations of the spoken utterances. For instance, the control device commands 150 can include digital representations of the spoken utterances generated by an analog to digital (A/D) converter or analog audio signals generated directly from the spoken utterances.

The control device commands 150 can be propagated to the server 120 via a communications network 130. The server 120 can be any of a variety of information processing systems capable of fielding requests and serving information over the communications network 130, for example a Web server. The communications network 130 can be the Internet, a local area network (LAN), a wide area network (WAN), a mobile or cellular network, another variety of communication network, or any combination thereof. Moreover, the communications network 130 can include wired and/or wireless communication links.

The multimodal application 125 on the server 120 can receive requests and information from the control device 110 and in return provide information, such as multimodal markup language documents. The multimodal markup language documents can be rendered by the multimodal browser in the control device 110 to present the multimodal user interface 115. The multimodal application 125 also can process the control device commands 150. For instance, the multimodal application 125 can extract specific control instructions from the control device commands 150. When appropriate, the multimodal application 125 can communicate with the audio processing services to convert control instructions contained in audio data to data recognizable by a wireless transmitter 135.

The multimodal application 125 also can cause server commands 155 containing the extracted control instructions to be propagated to the wireless transmitter 135 via a wired and/or a wireless communications link. In turn, the wireless transmitter 135 can wirelessly communicate appliance control commands 160 containing the control instructions to an appliance 140. In particular, the wireless transmitter 135 can propagate the appliance control commands 160 as electromagnetic signals in the radio frequency (RF) spectrum, the infrared (IR) spectrum, and/or any other suitable frequency spectrum(s). Propagation of such signals is known to the skilled artisan. In other arrangements, the wireless transmitter 135 and the server 120 can be incorporated into a single device, such as a computer, or the wireless transmitter 135 and the control device 110 can be incorporated into a single device. In yet another arrangement, control device 110, the server 120 and the wireless transmitter 135 can be contained in a single device, and the communications network 130 can be embodied as a communications bus with in the device. Nonetheless, the invention is not limited in this regard.

The appliance 140 can be any of a variety of appliances which include a receiver 145 to receive the appliance control commands 160 from the wireless transmitter 135, and which are capable of being remotely controlled by such signals. For example, the appliance 140 can be an entertainment center having an audio/video system, an oven, a dishwasher, a washing machine, a dryer, or any other device which is remotely controllable. The receiver 145 can be any of a variety of receivers that are known to those skilled in the art. Moreover, the wireless transmitter 135 can communicate with the receiver 145 using any of a number of conventional communication protocols, or using an application specific communication protocol.

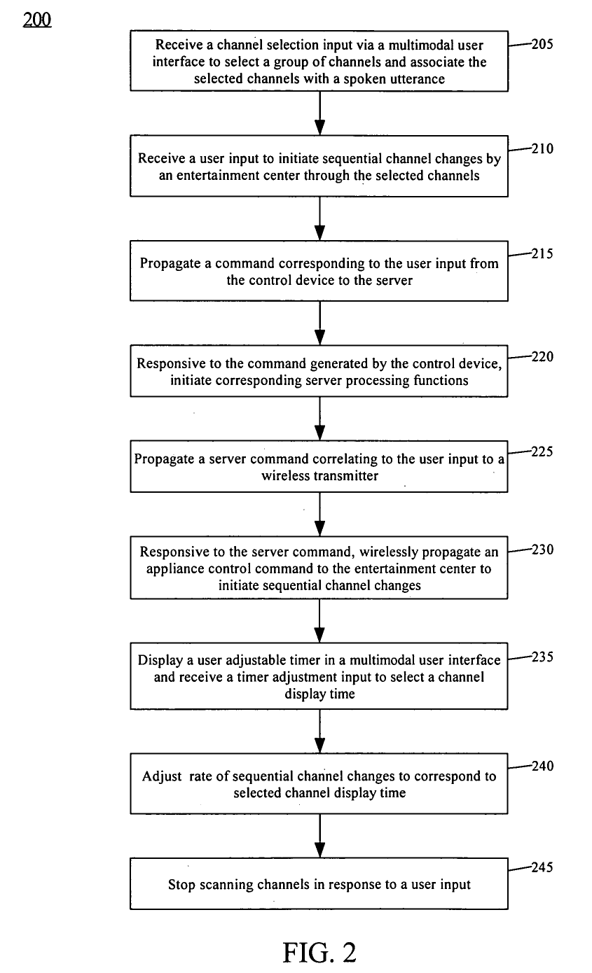

FIG. 2 is a flow chart 200 illustrating an example of a method of remotely controlling an appliance, such as an entertainment center, in accordance with an embodiment of the present invention. The method begins in a state where a multimodal document has been loaded into a multimodal browser on the device. The multimodal document can be stored locally or downloaded from the server responsive to a user request from the browser.

At step 205, a user can select a plurality of specific television channels via the multimedia user interface and associate the selected channels with a spoken utterance. For instance, using the multimodal browser, the user can select the channels via a stylus or tactile input and utter a phrase, such as “sports channels”, which the user wishes to associate with the channels. The user also can assign an action to perform on selected channels and associate a spoken utterance with the selected action. For example, the user can select a “scan” action and associate the “scan” action with selected channels. The user then can associate a spoken utterance, such as “scan sports channels” with the action to scan the selected channels. Still, the multimodal user interface can be used to facilitate any number of additional control actions to be performed on appliances and the invention is not limited in this regard.

At step 210 a user input, such as a spoken utterance, tactile input or stylus input, can be received by the multimodal user interface to initiate an action to be performed by a remotely controlled appliance. For instance, the user can utter “scan sports channels” when the user wishes to initiate sequential channel changes through the selected sports channels. At step 215, a command corresponding to the user input can be propagated from the control device to the server. Responsive to the control device command, the server can perform corresponding server processing functions, as shown in step 220. For instance, the server can determine a set of channels to scan after receiving a command such as “scan sports channels”. In particular, the server can select channels that were previously associated with the “scan sports channels” command.

At step 225, the server also can propagate a server command correlating to the user input to the wireless transmitter. Continuing to step 230, in response to the server command, the wireless transmitter can propagate an appliance control command to the entertainment center to initiate an action in accordance with the user input. In the present example, the server command can be selected by the server to cause the entertainment center to display the first identified sports channel. Accordingly, the appliance control command can be a command that causes the entertainment center to display the appropriate channel.

Proceeding to step 235, a user adjustable timer can be presented in the multimodal user interface. For instance, the user adjustable timer can be an adjustable JavaScript timer embedded in a multimodal page being presented by the multimodal browser. User inputs then can be received to adjust timer settings to select a display time for each channel. Continuing to step 240, the rate of sequential channel changes can be adjusted to correspond to the selected channel display time. For instance, the server can propagate a server command which causes the entertainment center to change to the next channel in the determined set of channels each time a channel change is to occur, as defined by the user adjustable timer. Advantageously, the user can enter user inputs to change timer settings to speed up or slow down the sequential presentation of channels when desired. Such a feature is useful to enable the user to quickly scan through channels in which the user is not interested, while also allowing the user to preview more interesting channels for a longer period of time. If a user input is not received to adjust timer settings, the channels changes can be initiated by the server at predetermined timer intervals.

Referring to step 245, the user can enter an input into the multimodal user interface to instruct the system to stop scanning the channels when desired. The channel being presently displayed when the user input is received by the multimodal user interface can continue to be displayed until a user input instructing the entertainment center to do otherwise is received. The adjustable timer can be canceled at this point and removed from display in the multimodal user interface.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software, or software application, in the present context, means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A method for remotely controlling an appliance, comprising:
receiving at least one user input comprising a spoken utterance via a multimodal user interface; and
propagating from a wireless transmitter an appliance control command correlating to the user input to remotely control the appliance.

2. The method according to claim 1, further comprising:
propagating a control device command correlating to the user input to a server; and
propagating a server command correlating to the user input to the wireless transmitter.

3. The method according to claim 1, further comprising the step of defining the appliance to be an entertainment center.

4. The method according to claim 3, wherein said propagating step further comprises initiating a channel change in the entertainment center.

5. The method according to claim 3, further comprising:
selecting a group of channels; and
initiating sequential channel changes through channels contained in the selected group of channels.

6. The method according to claim 5, further comprising:
displaying a user adjustable timer in the multimodal user interface; and
receiving a timer adjustment input from the user to establish a channel display time;
wherein the sequential channel changes occur at a rate defined by the channel display time.

7. The method according to claim 5, further comprising the step of halting the sequential channel changes in response to a stop channel change user input.

8. The method according to claim 1, wherein said user input further comprises a non-speech input.

9. The method according to claim 8, further comprising:
prior to said receiving at least one user input step, defining the appliance control command to correspond to the spoken utterance.

10. A system for remotely controlling an appliance, comprising:
a multimodal control device comprising multimodal user interface that receives at least one user input comprising a spoken utterance; and
a wireless transmitter that propagates an appliance control command correlating to the user input to remotely control the appliance.

11. The system of claim 10, further comprising a server that receives a multimodal control device command from the multimodal control device and propagates a server command to the wireless transmitter, wherein both the multimodal control device command and the server command correlate to the user input.

12. The system of claim 10, wherein said appliance is an entertainment center.

13. The system of claim 12, wherein the appliance control command initiates a channel change in the entertainment center.

14. The system of claim 13, wherein in response to the appliance control command a group of channels is selected, and sequential channel changes through channels contained in the selected group of channels is initiated.

15. The system of claim 14, wherein the multimodal user interface displays a user adjustable timer and receives a timer adjustment input from the user to establish a channel display time, and the channels are changed at a rate defined by the channel display time.

16. The system of claim 15, wherein sequential channel changes are halted in response to a stop channel change user input.

17. The system of claim 10, wherein the system further comprises a speech recognition system, and the multimodal interface receives the spoken utterance from the user and propagates data corresponding to the spoken utterance to the speech recognition system.

18. The system of claim 17, wherein the user input further comprises a non-speech input.

19. A machine readable storage, having stored thereon a computer program having a plurality of code sections executable by a machine for causing the machine to perform the steps of:
receiving at least one user input comprising a spoken utterance via a multimodal user interface; and
propagating from a wireless transmitter an appliance control command correlating to the user input to remotely control the appliance.

20. The machine readable storage of claim 19, further causing the machine to perform the steps of:
propagating a multimodal control device command correlating to the user input to a server; and
propagating a server command correlating to the user input to the wireless transmitter.
